(19) United States
(12) Patent Application Publication
(10) Pub. No.: US 2015/0332313 A1
(43) Pub. Date: Nov. 19, 2015

(54) Objective Prediction of an Ad Creative Based on Feature Scores

(71) Applicant: Facebook. Inc., Menlo Park, CA (US)

(72) Inventors: Daniel Slotwiner, Brooklyn, NY (US); Neha Bhargava, San Francisco, CA (US); Eurry Kim, Brooklyn, NY (US); David Yong Joon Pio, Santa Clara, CA (US); Robert Andrew Creekmore, Foster City, CA (US); Omid Saadati, San Mateo, CA (US); Tarun Kartikaye Sharma, Mountain View, CA (US)

(73) Assignee: Facebook. Inc., Menlo Park, CA (US)

(21) Appl. No.: 14/280,137

(22) Filed: May 16, 2014

(51) Int. Cl. G06Q 30/02

(52) U.S. Cl. CPC G06Q 30/0245

(57) ABSTRACT

An online system or third party system allows advertisers to evaluate and test ad creatives before the ad creatives are presented to users in an ad campaign. Based on a set of test ad creatives for which feature scores and objective scores are determined by content evaluators (e.g., users, content processing algorithms), a model is trained to determine objective scores for an ad creative based on feature scores of the ad creative. The trained model is applied to a target ad creative, which has yet to be or has been presented to users, to determine one or more objective scores for the target ad creative based on feature scores of the target ad creative. Feedback is presented to an advertiser associated with the target ad creative based on the objective scores determined for the target ad creative.

### BACKGROUND

This invention relates generally to presenting advertisements via an online system, and more particularly to evaluating advertisement for achieving an objective.

An online system allows its users to connect to and communicate with other online system users. Users may create profiles on an online system that are tied to their identities and include information about the users, such as interests and demographic information. The users may be individuals or entities such as corporations or charities. Because of the increasing popularity of online systems and the increasing amount of user-specific information maintained by online systems, such as social networking systems, an online system provides an ideal forum for advertisers to increase awareness about products or services by presenting advertisements to online system users.

Presenting advertisements to users of an online system allows an advertiser to gain public attention for products or services and to persuade online system users to take an action regarding the advertiser's products, services, opinions, or causes. Many online systems generate revenue by displaying advertisements to their users. Frequently, online systems charge advertisers for each presentation of an advertisement to an online system user (i.e., each “impression” of the advertisement) or for interaction with an advertisement by an online system user.

Often, an advertiser presents advertisements via an online system to achieve one or more objectives. For example, an advertiser may present advertisements using an online system to increase awareness of a product or service or to modify perception of a product or service. However, advertisers often have limited or no information about the likelihood of a new advertisement achieving one or more objectives when presented to online system users.

### SUMMARY

An online system trains a model to determine or predict one or more objective scores for an advertisement (ad) creative that measure a likelihood of the ad creative achieving one or more objectives. The trained model is applied to an ad creative received from an advertiser before the ad creative is presented to online system users. Based on application of the trained model to the received ad creative, the online system provides feedback to the advertiser that describes the likelihood of the ad creative achieving one or more objectives.

To train the model, the online system receives multiple test ad creatives from one or more advertisers and determines feature scores for each test ad creative based on responses from users to questions about features of a test ad creative, which correspond to content in the ad creative. The multiple test ad creatives can be previously presented ad creatives in the online system, ad creatives not yet presented in the online system, or any combination thereof. For example, the online system presents a test ad creative to multiple users and generates feature scores for the test ad creative along with questions about features of the test ad creative. From answers to the questions, the online system generates feature scores associated with various features of the test ad creative. Hence, the feature scores for various test ad creatives are generated based on answers to questions about various features of a test ad creative received from multiple users.

Because a feature of an ad creative describes content in the ad creative, a feature score associated with a feature represents a degree to which, or whether, the feature is represented in the ad creative. For test ad creatives, the feature scores are based on responses received from users about the content of various test ad creatives. Alternatively, feature scores may be based at least in part on content processing algorithms applied to an ad creative that determine a degree to which different features are present in the ad creative. Example features of an ad creative include: a focal point of the ad creative, a connection between the ad creative to a brand, a measure of how accurately the ad creative conveys a personality of a brand, an amount of information about a brand provided to a user by the ad creative, an emotional reward to a user from viewing the ad creative, a degree with which users notice an ad creative when presented with additional content, an indication whether an ad creative prompts users to act, or any other suitable content of the ad creative.

Additionally, users presented with a test ad creative provide information describing a likelihood of the test ad creative achieving an objective of the test ad creative, allowing the online system to generate objective scores associated with the test ad creative describing the likelihood of the test ad creative achieving one or more objectives. Thus, information received from multiple users allows the online system to maintain feature scores and objective scores associated with multiple test ad creatives. An objective score is associated with an objective and provides a measure of an ad creative, such as a test ad creative, achieving the objective. Example objectives include: promoting brand awareness of a product or service, promoting perception of a brand or product or service of the brand, or promoting purchase intent of a product or service associated with a brand.

Based on the feature scores and objective scores associated with various test ad creatives, the online system trains a model to determine one or more objective scores for an ad creative based on one or more feature scores. For example, the model is trained using simple linear regression, multiple linear regression, other suitable modeling algorithms, supervised learning, or any other suitable machine learning algorithm using feature scores and objective scores. The feature scores and/or objective scores can be received from users through crowdsourcing or automatically from content processing algorithms. The online system stores the trained model and subsequently receives a request from a requesting advertiser to evaluate a target ad creative for presentation to one or more users of the online system. The target ad creative includes a plurality of feature scores associated with various features of the target ad creative. The feature scores may be determined based on answers to questions about features received from content evaluators, such as multiple users, or may be determined based on content processing algorithms.

One or more objective scores are determined for the target ad creative by applying the trained model to one or more feature scores of the target ad creative. Various objective scores describe how well the target ad creative achieves various objectives. For example, the trained model determines an objective score by applying weights to various feature scores and combining the weighted feature scores. The trained model may apply different weights to feature scores to generate objective scores associated with different objectives. An objective score may be a binary score, a range of values, or any other suitable numerical value. In some embodiments, the objective score may be normalized.

Based on the objective scores determined for the target ad creative, the online system communicates feedback about the test ad creative to the requesting advertiser. The feedback may identify the target ad creative, may identify one or more features of the target ad creative, may identify one or more feature scores of the target ad creative, may identify one or more of the objectives, may identify one or more of the objective scores, or may identify any combination thereof. Additionally, the feedback may include information about additional ad creatives, such as one or more test ad creatives, and present the feedback as a comparison of the target ad creative to one or more of the additional ad creatives.

### BRIEF DESCRIPTION OF THE DRAWINGS

FIG. 1 is a block diagram of a system environment in which an online system operates, in accordance with an embodiment of the invention.

FIG. 2 is a block diagram of an online system, in accordance with an embodiment of the invention.

FIG. 3 is a concept diagram depicting relationships between an ad creative, features, and objectives, in accordance with an embodiment of the invention.

FIG. 4 is a flowchart of a method for training a model and predicting objective scores of an ad creative based on feature scores and the trained model, in accordance with an embodiment of the invention.

The figures depict various embodiments for purposes of illustration only. One skilled in the art will readily recognize from the following discussion that alternative embodiments of the structures and methods illustrated herein may be employed without departing from the principles described herein.

### DETAILED DESCRIPTION

### System Architecture

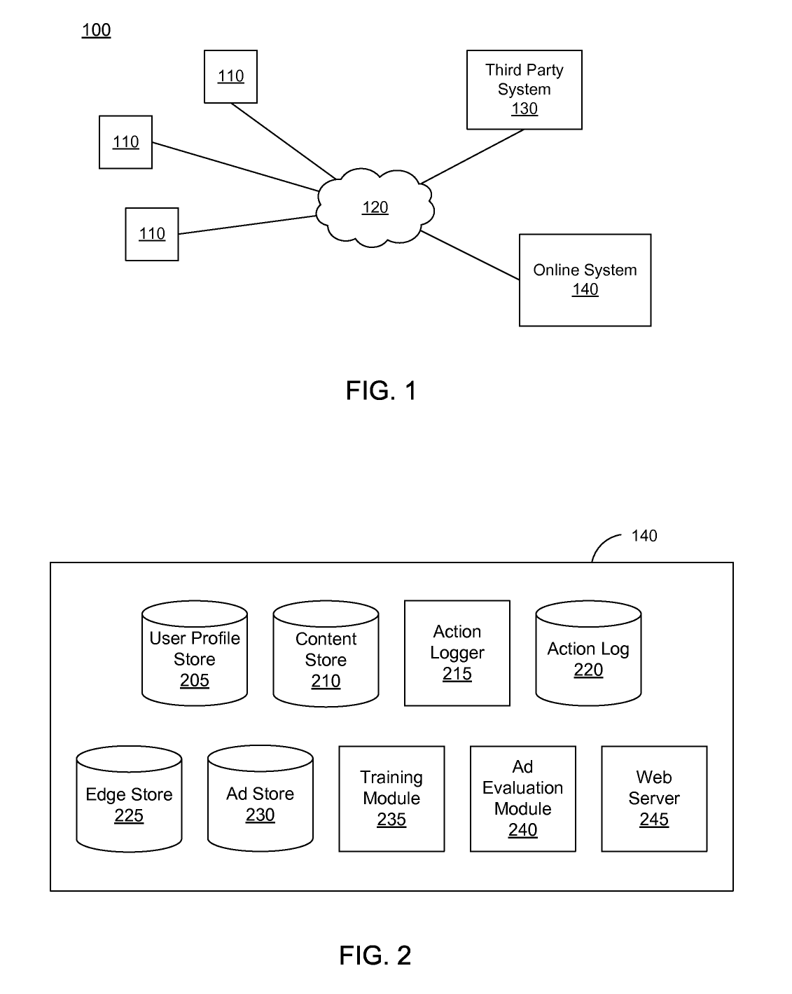

FIG. 1 is a high level block diagram of a system environment 100 for an online system 140. The system environment 100 shown by FIG. 1 comprises one or more client devices 110, a network 120, one or more third-party systems 130, and the online system 140. In alternative configurations, different and/or additional components may be included in the system environment 100. In some embodiments, the online system 140 is a social networking system.

The client devices 110 are one or more computing devices capable of receiving user input as well as transmitting and/or receiving data via the network 120. In one embodiment, a client device 110 is a conventional computer system, such as a desktop or laptop computer. Alternatively, a client device 110 may be a device having computer functionality, such as a personal digital assistant (PDA), a mobile telephone, a smartphone or another suitable device. A client device 110 is configured to communicate via the network 120. In one embodiment, a client device 110 executes an application allowing a user of the client device 110 to interact with the online system 140. For example, a client device 110 executes a browser application to enable interaction between the client device 110 and the online system 140 via the network 120. In another embodiment, a client device 110 interacts with the online system 140 through an application programming interface (API) running on a native operating system of the client device 110, such as IOS® or ANDROID™.

The client devices 110 are configured to communicate via the network 120, which may comprise any combination of local area and/or wide area networks, using both wired and/or wireless communication systems. In one embodiment, the network 120 uses standard communications technologies and/or protocols. For example, the network 120 includes communication links using technologies such as Ethernet, 802.11, worldwide interoperability for microwave access (WiMAX), 3G, 4G, code division multiple access (CDMA), digital subscriber line (DSL), etc. Examples of networking protocols used for communicating via the network 120 include multiprotocol label switching (MPLS), transmission control protocol/Internet protocol (TCP/IP), hypertext transport protocol (HTTP), simple mail transfer protocol (SMTP), and file transfer protocol (FTP). Data exchanged over the network 120 may be represented using any suitable format, such as hypertext markup language (HTML) or extensible markup language (XML). In some embodiments, all or some of the communication links of the network 120 may be encrypted using any suitable technique or techniques.

One or more third party systems 130 may be coupled to the network 120 for communicating with the online system 140, which is further described below in conjunction with FIG. 2. In one embodiment, a third party system 130 is an application provider communicating information describing applications for execution by a client device 110 or communicating data to client devices 110 for use by an application executing on the client device. In other embodiments, a third party system 130 provides content or other information for presentation via a client device 110. A third party website 130 may also communicate information to the online system 140, such as advertisements, content, or information about an application provided by the third party website 130. In one embodiment, one or more third-party systems 130 may provide the functionality of the training module 235 and/or the ad-evaluation module 240, described further below in conjunction with FIG. 2.

FIG. 2 is a block diagram of an architecture of the online system 140. In the example shown in FIG. 2, the online system 140 includes a user profile store 205, a content store 210, an action logger 215, an action log 220, an edge store 225, an advertisement (“ad”) store 230, a training module 235, an ad evaluation module 240, and a web server 245. In other embodiments, the online system 140 may include additional, fewer, or different components for various applications. For example, the training module 235 and/or the ad-evaluation module 240, as described previously, may be external to the online system 140, such as one or more third-party systems 130, and communicate information to the online system 140. Conventional components such as network interfaces, security functions, load balancers, failover servers, management and network operations consoles, and the like are not shown so as to not obscure the details of the system architecture.

Each user of the online system 140 is associated with a user profile, which is stored in the user profile store 205. A user profile includes declarative information about the user that was explicitly shared by the user and may also include profile information inferred by the online system 140. In one embodiment, a user profile includes multiple data fields, each describing one or more attributes of the corresponding online system user. Examples of information stored in a user profile include biographic, demographic, and other types of descriptive information, such as work experience, educational history, gender, hobbies or preferences, location and the like. A user profile may also store other information provided by the user, for example, images or videos. In certain embodiments, images of users may be tagged with information identifying online system users displayed in an image. A user profile in the user profile store 205 may also maintain references to actions by the corresponding user performed on content items in the content store 210 and stored in the action log 220.

While user profiles in the user profile store 205 are frequently associated with individuals, allowing individuals to interact with each other via the online system 140, user profiles may also be stored for entities such as businesses or organizations. This allows an entity to establish a presence on the online system 140 for connecting and exchanging content with other online system users. The entity may post information about itself, about its products or provide other information to users of the online system using a brand page associated with the entity's user profile. Other users of the online system may connect to the brand page to receive information posted to the brand page or to receive information from the brand page. A user profile associated with the brand page may include information about the entity itself, providing users with background or informational data about the entity.

The content store 210 stores objects that each represent various types of content. Examples of content represented by an object include a page post, a status update, a photograph, a video, a link, a shared content item, a gaming application achievement, a check-in event at a local business, a brand page, or any other type of content. Online system users may create objects stored by the content store 210, such as status updates, photos tagged by users to be associated with other objects in the online system, events, groups or applications. In some embodiments, objects are received from third-party applications or third-party applications separate from the online system 140. In one embodiment, objects in the content store 210 represent single pieces of content, or content “items.” Hence, online system users are encouraged to communicate with each other by posting text and content items of various types of media to the social networking system 140 through various communication channels. This increases the amount of interaction of users with each other and increases the frequency with which users interact within the online system 140.

The action logger 215 receives communications about user actions internal to and/or external to the online system 140, populating the action log 220 with information about user actions. Examples of actions include adding a connection to another user, sending a message to another user, uploading an image, reading a message from another user, viewing content associated with another user, and attending an event posted by another user. In addition, a number of actions may involve an object and one or more particular users, so these actions are associated with those users as well and stored in the action log 220.

The action log 220 may be used by the online system 140 to track user actions on the online system 140, as well as actions on third party systems 130 that communicate information to the online system 140. Users may interact with various objects on the online system 140, and information describing these interactions is stored in the action log 210. Examples of interactions with objects include: commenting on posts, sharing links, checking-in to physical locations via a mobile device, accessing content items, and any other suitable interactions. Additional examples of interactions with objects on the online system 140 that are included in the action log 220 include: commenting on a photo album, communicating with a user, establishing a connection with an object, joining an event to a calendar, joining a group, creating an event, authorizing an application, using an application, expressing a preference for an object (“liking” the object) and engaging in a transaction. Additionally, the action log 220 may record a user's interactions with advertisements on the online system 140 as well as with other applications operating on the online system 140. In some embodiments, data from the action log 220 is used to infer interests or preferences of a user, augmenting the interests included in the user's user profile and allowing a more complete understanding of user preferences.

The action log 220 may also store user actions taken on a third party system 130, such as an external website, and communicated to the online system 140. For example, an e-commerce website may recognize a user of an online system 140 through a social plug-in enabling the e-commerce website to identify the user of the social networking system 140. Because users of the online system 140 are uniquely identifiable, e-commerce websites, such as in the preceding example, may communicate information about a user's actions outside of the online system 140 to the online system 140 for association with the user. Hence, the action log 220 may record information about actions users perform on a third party system 130, including webpage viewing histories, advertisements that were engaged, purchases made, and other patterns from shopping and buying.

In one embodiment, an edge store 225 stores information describing connections between users and other objects on the online system 140 as edges. Some edges may be defined by users, allowing users to specify their relationships with other users. For example, users may generate edges with other users that parallel the users' real-life relationships, such as friends, co-workers, partners, and so forth. Other edges are generated when users interact with objects in the online system 140, such as expressing interest in a page on the online system, sharing a link with other users of the online system, and commenting on posts made by other users of the online system 140.

An edge may include various features each representing characteristics of interactions between users, interactions between users and object, or interactions between objects. For example, features included in an edge describe rate of interaction between two users, how recently two users have interacted with each other, the rate or amount of information retrieved by one user about an object, or the number and types of comments posted by a user about an object. The features may also represent information describing a particular object or user. For example, a feature may represent the level of interest that a user has in a particular topic, the rate at which the user logs into the online system 140, or information describing demographic information about a user. Each feature may be associated with a source object or user, a target object or user, and a feature value. A feature may be specified as an expression based on values describing the source object or user, the target object or user, or interactions between the source object or user and target object or user; hence, an edge may be represented as one or more feature expressions.

The edge store 225 also stores information about edges, such as affinity scores for objects, interests, and other users. Affinity scores, or “affinities,” may be computed by the online system 140 over time to approximate a user's interest in an object or another user of the online system 140 based on actions performed by the user. A user's affinity may be computed by the online system 140 over time to approximate a user's affinity for an object, interest, and other users in the online system 140 based on the actions performed by the user. Computation of affinity is further described in U.S. patent application Ser. No. 12/978,265, filed on Dec. 23, 2010, U.S. patent application Ser No. 13/690,254, filed on Nov. 30, 2012, U.S. patent application Ser. No. 13/689,969, filed on Nov. 30, 2012, and U.S. patent application Ser. No. 13/690,088, filed on Nov. 30, 2012, each of which is hereby incorporated by reference in its entirety. Multiple interactions between a user and a specific object may be stored as a single edge in the edge store 225, in one embodiment. Alternatively, each interaction between a user and a specific object is stored as a separate edge. In some embodiments, connections between users may be stored in the user profile store 205, or the user profile store 205 may access the edge store 225 to determine connections between users.

The ad store 230 stores a plurality of advertisement (“ad”) creatives, which are each associated with an advertiser. An ad creative is the content of an advertisement that is presented to an online system user when the advertisement is presented. The ad store 230 may include one or more test ad creatives, which have previously been presented to online system users, as well as ad creatives that have yet to be presented to online system users. For example, the one or more test ad creatives previously presented to online system users are known to generate a high conversion rate. A test ad creative may be an ad creative previously presented to users of the online system 140, an ad creative previously presented to users of a third-party system 130. Test ad creatives may be received from a third party system 130, such as an advertiser, or received from other sources separate from the online system 140.

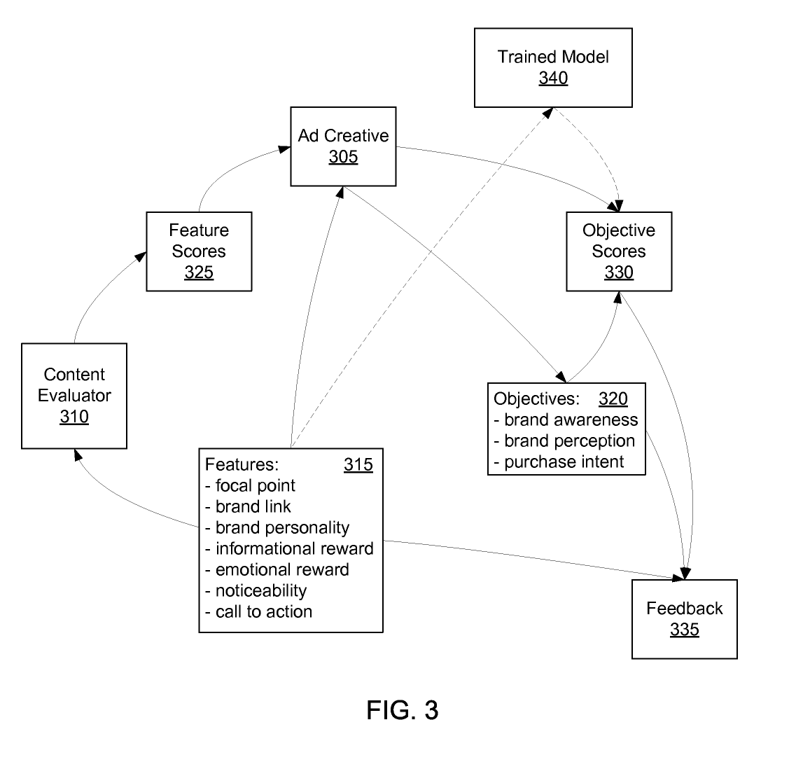

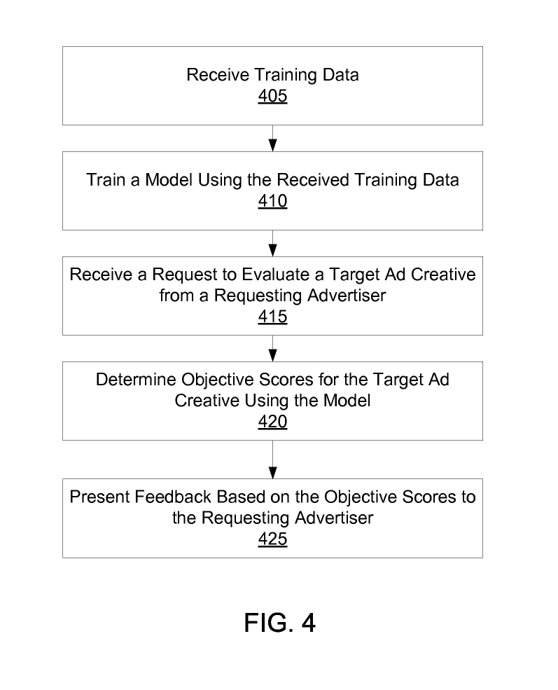

Each ad creative included in the ad store 230 includes one or more features, where each feature describes content in an ad creative. Feature scores are also associated with each ad creative, and a feature score provides a measure of a degree to which a feature is included in the content of an ad creative. In various embodiments, a feature score is determined based on answers to one or more questions associated with a feature received from various users. Additionally, ad creatives in the ad store 230 are associated with one or more objective scores, with each objective score providing a measure of an ad creative's effectiveness in achieving an objective. In one embodiment, an advertiser associates one or more objectives with an ad creative. Features, feature scores, objectives, and objective scores are further described below in conjunction with FIGS. 3 and 4. For a test ad creative, the feature scores and the objective scores are received from content evaluators (e.g., users of the online system 140, users of one or more third party systems 130, content processing algorithms), as further described in conjunction with FIG. 4. Features associated with the feature scores and objectives associated with the objective scores can be stored in the ad store 230 as well.

The training module 235 trains a model to determine one or more objective scores based on feature scores based on features of test ad creatives, feature scores associated with features of test ad creatives, and objective scores associated with test ad creatives. The degree with which various features are included in ad creatives provides indicators of whether an ad creative achieves, or is likely to achieve, various objectives. The presence or absence of different features may provide indications of how well an ad creative achieves different features. The training module 235 analyzes relationships or correlations between feature scores and objective scores associated with test ad creatives to train one or more models for predicting one or more objective scores for an ad creative based on feature scores associated with the ad creative. The training module 235 can train the one or more models using any suitable training method. Example training methods include simple linear regression, multiple linear regression, other suitable modeling algorithms, supervised learning, or any other suitable machine learning algorithm. In one embodiment, the trained model is stored in the training module 235. Alternatively, the trained model may be stored in the ad store 230. Training a model based on data associated with test ad creatives is further described below in conjunction with FIG. 4.

The ad evaluation module 240 receives an identification of an ad creative and identifies feature scores associated with the ad creative. The ad evaluation module 240 applies the trained model to the feature scores of the ad creative to determine one or more objective scores for the ad creative. Feature scores associated with the ad creative may be determined by the ad evaluation module 240 applying one or more content processing algorithms or may be received with the ad creative. Based on the determined objective scores, the ad evaluation module 240 provides feedback to the advertiser about the ad creative's effectiveness in achieving one or more objectives. For example, the feedback includes one or more objective scores and identifies objectives corresponding to each of the one or more objective scores. As another example, feedback provided to an advertiser by the ad evaluation module 240 identifies one or more features of an ad creative that influence an objective score by at least a threshold amount, allowing the advertiser to modify the identified features to influence the objective score. Thus, the feedback from the ad evaluation module 240 allows an advertiser to evaluate the ability of an ad creative to achieve one or more objectives, affecting whether the advertiser includes the ad creative in an ad campaign.

FIG. 3 is a conceptual diagram illustrating the relationship between an ad creative 305, features 315 of the ad creative, feature scores 325 associated with the ad creative 305, objectives 320, and one or more objective scores 330 associated with the ad creative 305. As described above in conjunction with FIG. 2, the ad creative 305 includes one or more features 325, which each describe content of the ad creative 305. Examples of features 315 of the ad creative 305 include whether the ad creative 305 includes a focal point, whether the ad creative 305 is linked to a brand, how the ad creative 305 presents a personality associated with a brand, an informational reward (i.e., an amount of information conveyed) to a user, an emotional reward to a user presented with the ad creative 305, how noticeable the ad creative 305 is to a user, and if the ad creative 305 identifies an action for the user to perform (i.e., a “call to action”).

The ad creative 305 is presented to one or more content evaluators 310, which answer one or more questions associated with features 315 of the ad creative 305. For example, the ad creative 305 is presented to multiple users of the online system 140 and/or users of one or more third party systems 130. The users are also presented with one or more questions that each correspond to one or more features of the ad creative 305, and feature scores 325 are generated for various features 315 based on received responses to the questions. For example, responses to questions associated with a feature 315 are used to generate a feature score 325 for the feature 315. Alternatively, one or more feature scores 325 are determined by applying content processing algorithms (e.g., object detection algorithms, intensity filter algorithms, gradient filter algorithms, edge detection algorithms, histogram analysis, or any other suitable image processing algorithm) to the ad creative 305 or by a combination of answers to questions associated with features 315 received from various users and application of one or more content processing algorithms to the ad creative 305. In some embodiments, the feature scores 325 may be determined by an advertiser and communicated to the online system 140 along with the ad creative 305. Evaluation of an ad creative is further described below in conjunction with FIG. 4.

Based on the feature scores 325, one or more objective scores 330 are determined for the ad creative 305. Each objective score 330 is associated with one or more objectives 320, with each objective score 330 providing a measure of the effectiveness of the ad creative 305 in achieving an objective 320. Example objectives 320 of the ad creative 305 include: increasing awareness of a brand, conveying a quality of a brand, and conveying images or other information to identify a brand. If the ad creative 305 is a test ad creative, information received from users presented with the ad creative 305 is used to generate the objective scores 330. Alternatively, if the test ad creative was previously presented to users of an online system, historical data of performance (e.g., ad recall, perception of the brand, purchase intent, online sales, in-store sales) of the test ad creative can be used to generate the objective scores 330. However, if the ad creative 305 is not a test ad creative, the model 340 trained by the training module 235 is applied to the feature scores 325 associated with the test ad creative (i.e., receives feature scores 325 associated with the test ad creative) to generate the objective scores 330. Based on the objective scores 330, feedback 335 is provided to an advertiser associated with the ad creative 305 describing the effectiveness of the ad creative 305 in achieving one or more objectives 320. The feedback may identify the ad creative 305, identify one or more of the objectives 320, and identify one or more of the objective scores 330. In some embodiments, the feedback 335 may also identify one or more features 315 of the ad creative 305. The feedback 335 may also include information about additional ad creatives, such as one or more test ad creatives, and present information comparing the ad creative 305 to the one or more test ad creatives.

Referring back to FIG. 2, the web server 245 links the online system 140 via the network 120 to the one or more client devices 110, as well as to the one or more third party systems 130. The web server 245 serves web pages, as well as other web-related content, such as JAVA®, FLASH®, XML and so forth. The web server 245 may receive and route messages between the online system 140 and the client device 110, for example, instant messages, queued messages (e.g., email), text messages, short message service (SMS) messages, or messages sent using any other suitable messaging technique. A user may send a request to the web server 245 to upload information (e.g., images or videos) that are stored in the content store 210. Additionally, the web server 245 may provide application programming interface (API) functionality to send data directly to native client device operating systems, such as IOS®, ANDROID™, WEBOS® or BlackberryOS.

### Evaluating an Ad Creative Achieving an Objective Based on Feature Scores of the Ad Creative

FIG. 4 is a flowchart of one embodiment of a method for training a model to predict objective scores of an ad creative based on feature scores associated with the ad creative. In other embodiments, the method may include different and/or additional steps than those shown in FIG. 4. Additionally, steps of the method may be performed in different orders than the order described in conjunction with FIG. 4.

Initially, the online system 140 receives 405 training data including a plurality of test ad creatives that are each associated with an advertiser. Additionally, each test ad creative includes one or more features describing content in the test ad creative. Feature scores corresponding to each feature in a test ad creative are associated with a test ad creative and each test ad creative is also associated with objective scores. A feature score provides a measure of a degree to which a feature is included in content of an ad creative and an objective score measures the ad creative's effectiveness in achieving the associated objective. The feature scores associated with a test ad creative may be determined based on answers to one or more questions associated with features received from various users presented with the test ad creative and, similarly, the objective scores can be determined from information received from users presented with the test ad creatives. Regarding features, for example, users of a third party system 130 or users of the online system 140 are presented with a test ad creative as well as questions each associated with a corresponding feature of the test ad creative. Based on the users' answers to a question associated with a feature of a test ad creative, a feature score for the feature is determined and associated with the test ad creative. Alternatively, a feature score corresponding to a feature of a test ad creative is determined by applying one or more content processing algorithms to content of the test ad creative to determine a degree to which the feature is present in the test ad creative. A feature score of a feature of an ad creative may be an average value of multiple feature scores received from multiple users or determined through application of various content processing algorithms to the ad creative. In some embodiments, the feature scores may be normalized to a common scale; for example, feature scores are normalized to a scale from 0 to 1 or to a scale from 0 to 10. In other embodiments, some feature scores are binary values or expressed using any suitable form of measurement. Further, different feature scores may be expressed using different scales in some embodiments and may be expressed using a common scale in other embodiments.

Example features of an ad creative, such as a test ad creative, include: a focal point, a brand link, a brand personality, an informational reward, an emotional reward, a measure of noticeability, a call to action, or any other suitable content of the ad creative. For example, a focal point of an ad creative indicates whether the ad creative includes one or more regions capturing a user's attention, and a feature score for a focal point is determined based on answers to a question of whether a user's attention is drawn to a portion of the ad creative. A brand link feature provides an indication of how readily users identify an advertiser associated with an ad creative, while a brand personality feature provides a measure of how closely the content of the ad creative is consistent with a user's (e.g., an average user of the online system 140 or an average user of a third party system 130) knowledge of an advertiser. An informational reward indicates whether the ad creative includes content that a user determines to be of interest to the user, while an emotional reward feature indicates whether the ad creative elicits a positive emotional response from a user. For example, content in an ad creative of interest to a user includes information about the advertiser associated with the ad creative or information about a product or service being advertised using the ad creative. Examples of a positive emotional response of a user to an ad creative include happiness, amusement, or any other suitable positive emotion. The noticeability feature provides an indicator of whether an ad creative captures a user's attention when presented along with other content. Noticeability of an ad creative may be based on vibrancy of color of the ad creative, organization of various types of content (e.g., text, pictures, text and pictures) of the ad creative, identification of a main subject of the ad creative, or any combination thereof. A call to action feature is based on whether the ad creative identifies an action for a user to perform (e.g., interacting with the ad creative, installing an application). Questions corresponding to various features (e.g., whether an ad creative has a focal point, whether an ad creative captures a user's attention, a description of a user's emotional response to an ad creative, etc.) are presented to users, and feature scores associated with various features are generated based on responses to the questions received from various users.

As stated previously, an objective score of an ad creative associated with an objective measures the ad creative's effectiveness in achieving the associated objective. An objective may be specified by an advertiser associated with the ad creative. Examples of objectives include promoting brand awareness of a product or service, promoting perception of a brand or product or service of the brand, or promoting purchase intent of a product or service associated with a brand. Promoting brand awareness can include increasing awareness of the brand (e.g., name or owner), increasing awareness of quality of the brand, increasing awareness of imagery identified by the brand, or any other suitable means of increasing awareness for or recall of an advertiser. Promoting brand perception can include increasing awareness of products or services of a brand, increasing awareness of quality of the products or services, increasing awareness of imagery identified by the products or services of a brand, or any other suitable means of increasing awareness for or recall of an advertiser's product or service. Promoting purchase intent can include increasing awareness of effects of use of products or services of a brand, increasing awareness of known effects of use of products or services of a brand, increasing awareness of cost of products or services of a brand, or any other suitable means of increasing awareness of beneficial effects of use of products or services of a brand. For example, an advertiser's objective for an ad creative may be to increase a number of users aware of a product, a brand or a service. As another example, an objective of an ad creative is to notify users of a quality associated with an advertiser's product, service, or brand to increase users' confidence in the product, service, or brand. In another example, an ad creative's objective is to associate a product, service, or brand with an image (e.g., a lifestyle, an emotion, a type of consumer). In yet another example, an ad creative's objective is to associate a product, service, or brand with a high cost versus benefit ratio (e.g., low prices, product or service versus price, effect of product or service versus price).

Objective scores associated with test ad creatives are determined from information received from users presented with the test ad creatives. For example, multiple users presented with a test ad creative provide information describing the test ad creative's effectiveness in achieving one or more objectives, and the provided information is analyzed to determine objective scores associated with one or more objectives. In one embodiment, users presented with a test ad creative are prompted to provide a numerical value indicating the test ad creative's effectiveness in achieving different objectives, and numerical scores received from multiple users for an objective are averaged or otherwise combined to generate an objective score for the objective. In various embodiments, objective scores are normalized to a specified value, such as 1 or 10, or may be represented using any suitable numerical values. Additionally, objective scores may be represented using binary values or using any suitable form of measurement in some embodiments. Further, different objective scores may be expressed using different scales in some embodiments and may be expressed using a common scale in other embodiments.

The online system 140 trains 410 a model to determine one or more objective scores based on the received training data. Based on the feature scores and objective scores associated with various test ad creatives from the training data, the model is trained 410 to determine one or more objective scores for an ad creative based on the feature scores associated with the ad creative. In some embodiments, for an objective score, the model determines weights associated with various feature scores of an ad creative so that the weighted feature scores are combined to generate the objective score. The model may be trained 410 using simple linear regression, multiple linear regression, other suitable modeling algorithms, supervised learning, or any other suitable machine learning algorithm as described above in conjunction with FIG. 2. The trained model is stored by the online system 140.

After storing the trained model, the online system 140 receives 415 a request from a requesting advertiser to evaluate a target ad creative for presentation to one or more users of the online system 140. The target ad creative includes, or is associated with, a plurality of feature scores that are based on previously-received answers to questions about content of the target ad creative. In various embodiments, the requesting advertiser determines the feature scores based on answers from users to questions associated with different features of the target ad creative or determines the feature scores by applying one or more content processing algorithms to the target ad creative. The requesting advertiser communicates the feature scores to the online system 140 along with the target ad request. Alternatively, the online system 140 determines the feature scores included in the target ad creative by presenting the target ad creative to users along with questions describing content of the target ad creative; based on the received answers to a question, the online system 140 determines a feature score corresponding to a feature associated with the questions. In some embodiments, the online system 140 applies one or more content processing algorithms to the target ad creative to determine feature scores for the target ad creative. The online system 140 may also receive 415 one or more objectives specified by the requesting advertiser for the target ad creative. For example, an advertiser specifies one or more of increasing awareness of a brand, increasing awareness of quality of the brand, and increasing awareness of imagery identified by a brand as objectives for the target ad creative.

By applying the trained model to the feature scores included in, or associated with, the target ad creative, the online system 140 determines 420 an objective score for one or more objectives for the target ad creative. For example, the trained model applies various weights to feature scores and combines the weighted feature scores to generate an objective score; hence, in the trained model, different feature scores have different contributions to an objective score. The model may associate different weights with a feature score to determine 420 different objective scores. For example, different weights are associated with a feature score corresponding to a focal point feature when computing an objective score for an objective of increasing brand awareness and computing an objective score for an objective of associating an image with a brand. As described above, objective scores may be normalized based on a specified value, and, in some embodiments, different objective scores are expressed using different scales. If an advertiser specifies one or more objectives, objective scores are determined 420 for at least the specified objectives.

Based on the determined objective scores, the online system 140 generates feedback for the requesting advertiser about the target ad creative and presents 425 the feedback to the requesting advertiser. The presented feedback may identify various objectives and their corresponding objective scores, allowing the requesting advertiser to gauge the effectiveness of the target ad creative in achieving various objectives. In other embodiments, the feedback identifies an objective and presents a value based on an objective score associated with the objective. For example, a value based on a range of objective scores that includes an objective score is presented (e.g., “high” if the objective score is within a range of values and “medium” if the objective score is within an additional range of values, or “low” if the objective score is within an additional range of values).

In some embodiments, the feedback presented 425 to the requesting advertiser identifies features that contributed to an objective score for the target ad creative. For example, features corresponding to feature scores to which the trained model applies maximum weights or applies weights having at least a threshold value are identified by the feedback. Feature scores corresponding to the identified features may also be presented 425 in the feedback in some embodiments. This allows the requesting advertiser to identify features to improve or change in the target ad creative to better achieve an objective. In addition, one or more objective scores determined 420 for the target ad creative may be shown in the feedback in comparison to one or more objective scores of additional ad creatives. For example, objective scores of additional ad creatives similar to the target ad creative are included in the feedback. As another example, objective scores of additional ad creatives associated with additional advertisers similar to the requesting advertiser of the target ad creative or objective scores of additional ad creatives associated with similar products or services as the target ad creative are presented 425 in the feedback. Additional ad creatives identified in feedback presented 425 to the requesting advertiser may be test ad creatives or otherwise previously-evaluated ad creatives.

### Summary

The foregoing description of the embodiments has been presented for the purpose of illustration; it is not intended to be exhaustive or to limit patent rights to the precise forms disclosed. Persons skilled in the relevant art can appreciate that many modifications and variations are possible in light of the above disclosure.

Some portions of this description describe the embodiments in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the patent rights. It is therefore intended that the scope of the patent rights be limited not by this detailed description, but rather by any claims that issue on an application based hereon. Accordingly, the disclosure of the embodiments is intended to be illustrative, but not limiting, of the scope of the patent rights, which is set forth in the following claims.

What is claimed is:

1. A method comprising:
receiving training data comprising:
a plurality of test ad creatives, each test ad creative associated with an advertiser and associated with one or more features, each feature associated with a question describing content of a test ad creative;
a plurality of feature scores for each test ad creative in the plurality of test ad creatives, each feature score of the test ad creative based at least in part on received answers to a question associated with a corresponding feature of the test ad creative; and
one or more objective scores for each test ad creative in the plurality of test ad creatives, each objective score of the test ad creative measuring how well the test ad creative achieves an objective;
training a model that is usable to determine one or more objective scores based on one or more feature scores using the training data;
receiving a request to evaluate a target ad creative from a requesting advertiser of an online system for presentation to one or more users of the online system, the target ad creative comprising a plurality of feature scores based on received answers to questions describing content of the target ad creative;
determining an objective score for one or more objectives for the target ad creative by applying the trained model to one or more features scores of the target ad creative; and
presenting feedback to the requesting advertiser based at least in part on the objective scores of the target ad creative.

2. The method of claim 1, wherein a feature of an ad creative is selected from a group consisting of: an indication whether the target ad creative includes one or more regions capturing a user's attention, an indication of how readily the user identifies the advertiser associated with the ad creative, a measure of how closely the content of the ad creative is consistent with the user's knowledge of the advertiser, an indication whether the ad creative includes content that the user determines to be of interest, an indication whether the ad creative elicits a positive emotional response from the user, an indication of whether an ad creative captures the user's attention when presented along with other content, an indication whether the ad creative identifies an action for the user to perform, and any combination thereof.

3. The method of claim 1, wherein an objective of an ad creative is selected from a group consisting of: increasing awareness of a brand, increasing awareness of quality of the brand, increasing awareness of an image associated with the brand, increasing awareness of a product of the brand, increasing awareness of a service of the brand, increasing awareness of quality of a product of the brand, increasing awareness of an image associated with a service of the brand, increasing awareness of cost of a product of the brand, increasing awareness of cost of a service of the brand, increasing awareness of a cost to benefits ratio of a product of the brand, increasing awareness of a cost to benefits ratio of a service of the brand, and any combination thereof.

4. The method of claim 1, wherein a plurality of feature scores for a test ad creative are determined based at least in part on answers to one or more questions associated with corresponding features from multiple users presented with the test ad creative.

5. The method of claim 4, wherein one or more objective scores for the test ad creative are determined based at least in part on information identifying one or more objectives of the test ad creative received from multiple users.

6. The method of claim 1, wherein a plurality of feature scores for a test ad creative are determined based at least in part on one or more from a group consisting of: object detection algorithms, intensity filter algorithms, gradient filter algorithms, edge detection algorithms, histogram analysis, or any combination thereof.

7. The method of claim 1, wherein training the model to determine one or more objective scores based on one or more feature scores comprises:
determining weights associated with each feature score to generate an objective score by combining feature scores after application of the weights.

8. The method of claim 1, wherein the model is trained using linear regression or supervised learning.

9. The method of claim 1, wherein the request to evaluate the target ad creative includes one or more objectives for the target ad creative specified by the requesting advertiser.

10. The method of claim 9, wherein determining the objective score for one or more objectives for the target ad creative comprises:
determining an objective score for each of the one or more objectives for the target ad creative specified by the requesting advertiser by applying the trained model to the one or more feature scores of the target ad creative.

11. The method of claim 1, wherein the feedback includes an identification of an objective and information based on an objective score associated with the objective.

12. The method of claim 11, wherein the information based on the objective score associated with the objective comprises the objective score.

13. The method of claim 11, wherein the information based on the objective score comprises an identification of one or more features having at least a threshold contribution to the objective score by the trained model.

14. A method comprising:
receiving a request to evaluate an ad creative from an advertiser for presentation to one or more users of an online system, the ad creative comprising a plurality of feature scores based on received answers to questions describing corresponding features of the ad creative;
determining an objective score for one or more objectives for the ad creative by applying a model to one or more feature scores of the ad creative, the model trained using feature scores and objective scores of additional ad creatives that were previously presented and each objective score providing a measure of success of the ad creative in achieving an objective; and
presenting the feedback to the advertiser based at least in part on the objective scores of the ad creative.

15. The method of claim 14, wherein the request to evaluate the ad creative includes one or more objectives for the ad creative specified by the advertiser.

16. The method of claim 15, wherein determining the objective score for one or more objectives for the ad creative comprises:
determining an objective score for each of the one or more objectives for the ad creative specified by the advertiser by applying the trained model to the one or more feature scores of the ad creative.

17. The method of claim 14, wherein the feedback includes an identification of an objective and information based on an objective score associated with the objective.

18. The method of claim 14, wherein the information based on the objective score associated with the objective comprises the objective score.

19. The method of claim 14, wherein the information based on the objective score comprises an identification of one or more features having at least a threshold contribution to the objective score by the trained model.

20. The method of claim 14, wherein a feature of the ad creative is selected from a group consisting of: an indication whether the target ad creative includes one or more regions capturing a user's attention, an indication of how readily the user identifies the advertiser associated with the ad creative, a measure of how closely the content of the ad creative is consistent with the user's knowledge of the advertiser, an indication whether the ad creative includes content that the user determines to be of interest, an indication whether the ad creative elicits a positive emotional response from the user, an indication of whether an ad creative captures the user's attention when presented along with other content, an indication whether the ad creative identifies an action for the user to perform, and any combination thereof.

21. The method of claim 14, wherein an objective of the ad creative is selected from a group consisting of: increasing awareness of a brand, increasing awareness of quality of the brand, increasing awareness of an image associated with the brand, increasing awareness of a product of the brand, increasing awareness of a service of the brand, increasing awareness of quality of a product of the brand, increasing awareness of an image associated with a service of the brand, increasing awareness of cost of a product of the brand, increasing awareness of cost of a service of the brand, increasing awareness of a cost to benefits ratio of a product of the brand, increasing awareness of a cost to benefits ratio of a service of the brand, and any combination thereof.

22. The method of claim 14, wherein a plurality of feature scores for an additional test ad creative are determined based at least in part on answers to one or more questions associated with corresponding features from multiple users that were previously presented with one or more of the additional ad creatives.

23. A computer program product comprising a computer-readable storage medium having instructions encoded thereon that, when executed by a processor, cause the processor to:
receive a request to evaluate an ad creative from an advertiser for presentation to one or more users of an online system, the ad creative comprising a plurality of feature scores based on received answers to questions describing corresponding features of the ad creative;
determine an objective score for one or more objectives for the ad creative by applying a model to one or more feature scores of the ad creative, the model trained using feature scores and objective scores of additional ad creatives that were previously presented and each objective score providing a measure of success of the ad creative in achieving an objective; and
present the feedback to the advertiser based at least in part on the objective scores of the ad creative.
